(19) United States
(12) Patent Application Publication
(10) Pub. No.: US 2002/0118909 A1
(43) Pub. Date: Aug. 29, 2002

(54) Signal monitoring in an optical cross-connect

(75) Inventor: Bernd X. Weis, Korntal (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/068,850

(22) Filed: Feb. 11, 2002

(30) Foreign Application Priority Data
Feb. 26, 2001 (EP) 01 440 047.7

(51) Int. Cl. G02B 6/35; G02B 5/08

(52) U.S. Cl. 385/18; 359/872

(57) ABSTRACT

An optical cross-connect (OCX) contains an optical switching array (A, S) based on MEM technology, which is used for switching optical connections. The switching array (A) consists of a plurality of movable miniature mirrors (M), with a reflective coating (RL), respectively arranged in the light path of the individual optical connections. In order to generate a monitoring signal for each of the optical communication signals to be switched, a light component (THRU) passing through the reflective coating (RL) is detected at least at some of the miniature mirrors (M). To that end, the miniature mirror (M) has a photosensitive layer (PL) which is arranged under a light-reflecting layer (RL) and which responds to the light components (THRU) passing through the light-reflecting layer, in order to generate the monitoring signal.

The present invention is based on a priority application EP 01440047.7, which is incorporated by reference herein.

### FIELD OF THE INVENTION

The invention relates to the field of telecommunications and more particularly to signal monitoring in an optical cross-connect based on MEM technology. More specifically, the invention relates to a miniature mirror for use in an optical cross-connect, having a light-reflecting layer, to an optical cross-connect for switching a plurality of optical connections with an optical MEM switching array, which consists of a plurality of movable miniature mirrors respectively arranged in the light path of the individual optical connections, to an optical switching array based on MEM technology for an optical cross-connect, the switching array consisting of a plurality of movable mirrors, and to a method for generating a monitoring signal during the purely optical switching of an optical connection in an optical cross-connect by means of a miniature mirror.

### BACKGROUND OF THE INVENTION

In the field of telecommunication, with increasing volumes of data and transmission rates, the switching of optical communication signals is becoming a key function. For the most part, optical communication signals are electrically processed and switched at present, although purely optical solutions will gain importance in the future. For purely optical switching of communication signals, which is also referred to as photonic switching, there are currently several approaches. In particular, optical switching arrays based on so-called MEM technology are currently regarded as especially promising. The acronym MEM stands for “Micro Electro-Mechanical Systems”, and describes an arrangement in which movable miniature mirrors are arranged as a two- or three-dimensional array. Each individual miniature mirror of the array can be driven and positioned in such a way that it routes an optical signal from an input to a selected output. A review of MEM technology can be found in the article “HEMS Brings New Solutions to Photonic Switching” by M. Fernandez and E. Kruglick, which is available on the Internet at http://www.omminc.com/technology/.

Besides the actual switching, one of the most difficult problems in this approach is the monitoring of the optical communication signals. To date, an optical communication signal has been monitored by extracting part of the light signal as a monitoring signal by using a passive splitter, and amplifying and forwarding the remaining signal. In order to compensate for signal losses, elaborate and expensive optical amplifiers such as fibre amplifiers and semiconductor amplifiers are needed.

It is therefore an object of the invention to simplify the signal monitoring during the purely optical switching of communication signals. In particular, the object of the invention is to provide a method for generating a monitoring signal, as well as a miniature mirror, an optical switching array and optical cross-connect, in which optical signal monitoring can be carried out with low technical outlay.

### SUMMARY OF THE INVENTION

The object is achieved in relation to the miniature mirror by the fact that a photosensitive layer is arranged under the light-reflecting layer and responds to the light components passing through the reflective layer.

The optical cross-connect according to the invention contains an MEM switching array, which consists of a plurality of movable miniature mirrors respectively arranged in the light path of the individual optical connections, at least some of the miniature mirrors respectively having a photosensitive layer which is arranged under a light-reflecting layer and which responds to the light components passing through the light-reflecting layer, in order to generate a monitoring signal.

The switching array based on MEM technology according to the invention consists of a plurality of movable mirrors, at least some of the miniature mirrors respectively having a photosensitive layer which is arranged under a light-reflecting layer and which responds to the light components passing through the light-reflecting layer, in order to generate a monitoring signal.

In relation to the method, the object is achieved by the fact that, in order to generate a monitoring signal during the purely optical switching of an optical connection by means of a miniature mirror, light components which pass through a reflecting layer of the miniature mirror are detected.

The invention has the advantage that switched light signals are not additionally attenuated by passive optical splitters which are used to extract a monitoring signal. It is therefore possible to save on optical amplifiers and the maximum distance between signal regenerators is increased. Further advantageous configurations can be found in the dependent claims.

### BRIEF DESCRIPTION OF THE DRAWINGS

The invention will be explained below in an exemplary embodiment with reference to FIGS. 1 to 3, in which:

FIG. 1 shows an array of miniature mirrors which is known per se,

FIG. 2 shows a miniature mirror according to the invention, and

FIG. 3 shows an optical cross-connect.

### DETAILED DESCRIPTION OF THE INVENTION

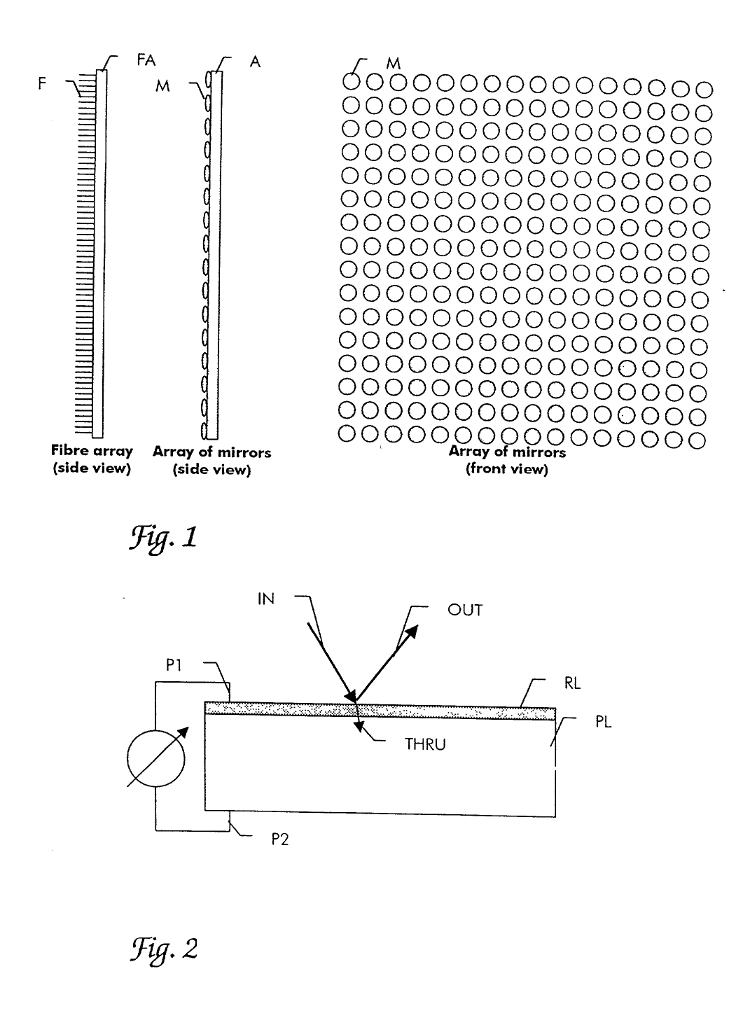

FIG. 1 represents the principle of an MEM switching array. The switching array A consists of a number of miniature mirrors M, which are arranged in a two-dimensional array. The miniature mirrors are tiltably fastened, and they can be individually driven and positioned. The driving of the mirrors takes place electrostatically or electromagnetically, and is controlled by a control instrument (not shown). The right-hand part of FIG. 1 represents a plan view of an array of miniature mirrors M. A side view can be seen to the left of this. In relation to the switching array, optical fibres F in a fibre array FA are aligned in such a way that light from any first fibre strikes one of the miniature mirrors, and is reflected from it to a selected second fibre.

A basic concept of the invention is then that light components, which inevitably pass through the reflective coating of a miniature mirror, are detected as a monitoring signal.

To that end, the miniature mirrors are designed as shown in FIG. 2. They have an upper light-reflecting coating RL, under which a photosensitive layer PL is arranged. The photosensitive layer PL may, for example, be a semiconductor layer which has first doping and is applied to a substrate with second doping, with respect to which it has a pn junction so that it forms a photodiode. Light components THRU, which pass through the reflective layer RL, induce a photovoltage at the pn junction, which can be tapped as a monitoring signal from two terminals P1, P2. The reflective coating RL can advantageously be used at the same time as a metal contact for the upper terminal P1.

The invention makes use of the fact that, during reflection from an electrically conductive material, some of the light waves always penetrate the reflector. The reflective layer RL therefore advantageously consists of a good electrical conductor, which is at the same time a very good reflector, e.g. silver. The penetrating light component is used to stimulate the underlying photosensitive semiconductor layer PL and hence to generate a photocurrent which is proportional to the field strength of the incident light beam IN. The layer thickness of the reflective layer RL is to be selected as a function of the sensitivity of the photosensitive layer PL, specifically so that a sufficiently large photocurrent is just generated by an incident optical signal.

Since the monitoring signals need to be evaluated with respect to their content, it is necessary to obtain them as electrical signals. An advantage of the invention is that the monitoring signal is immediately in the form of an electrical signal, so that no O/E conversion is necessary. Typical tasks for which a monitoring signal is used are: error monitoring with the aid of test data contained in the communication signal, and evaluation of control or signal information contained in the communication signal, e.g. for the purpose of network management or checking destination addresses.

A plurality of miniature mirrors according to the invention are grouped as an array, which is then used at the same time as a switching array for the purely optical switching of optical signals, as well as for the generation of electrical monitoring signals. The switching and monitoring devices are therefore combined in a single device. Additional signal losses due to the signal monitoring, e.g. due to passive optical splitters, are therefore avoided.

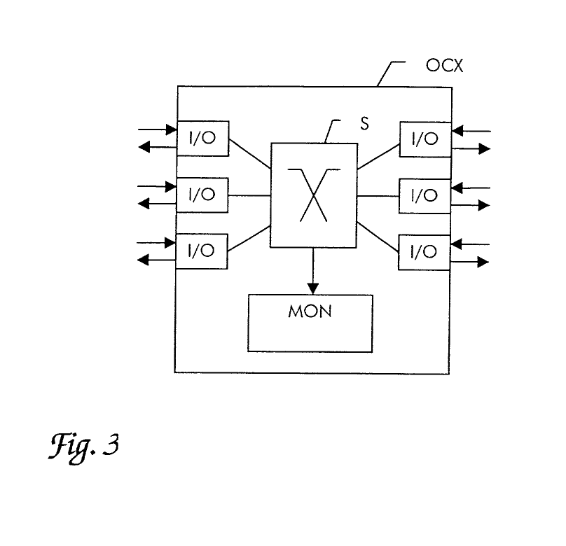

The schematic structure of an optical cross-connect OCX is represented in FIG. 3. It has a series of optical terminal modules I/O. These receive and transmit optical signals. At them, the optical signals are e.g. amplified, regenerated and/or subjected to a so-called Forward-Error Correction (FEC). Received signals are fed to a central optical switching array S. The switching array S is an array of miniature mirrors. The said switching array is used to switch each of the received optical signals to a respective selected output. According to the invention, at least some of the mirrors are equipped with a photosensitive layer, which detects light components that pass through the overlying reflective layer. Electrical monitoring signals generated in this way are sent by the switching array to a monitoring instrument MON. The monitoring instrument MON carries out the said monitoring functions such as error monitoring or evaluation of control or signalling information.

The monitoring instrument MON may also carry out any other desired monitoring functions with the aid of the monitoring signals. The monitoring signal can be used e.g. to set the gain of optical amplifiers in the optical terminal modules I/O since, as described above, the electrical monitoring signal is proportional to the field strength of the optical signal. If the monitoring instrument recognises that a monitoring signal is weaker than a predefined threshold value, then it turns up the optical input amplifier in the terminal module where the respective optical signal was received. If a monitoring signal for one of the miniature mirrors is missing completely, or the gain at the relevant input cannot be set higher, then the monitoring circuit generates a corresponding alarm, e.g. LOS (loss of signal). These examples clearly demonstrate that the person skilled in the art will be able to conceive of very many uses for the monitoring signal generated according to the invention.

Of course, not all miniature mirrors of the optical switching array of the cross-connect need to be configured for the monitoring-signal generation according to the invention. If, depending on the design of the switching array, the communication signal to be switched is reflected from a plurality of miniature mirrors before it has finished travelling from an array input to an array output, then it is naturally sufficient to generate a monitoring signal at only one of the miniature mirrors which are involved. Advantageously, a single monitoring signal for each communication signal to be switched can hence be generated and sent to the monitoring instrument MON.

What is claimed is:

1. A miniature mirror for use in an optical cross-connect, comprising a light-reflecting layer and a photosensitive layer which is arranged under the light-reflecting layer and which responds to the light components passing through the light-reflecting layer.

2. A miniature mirror according to claim 1, in which the light-reflecting layer consists of a material with high electrical conductivity.

3. A miniature mirror according to claim 1, in which the photosensitive layer consists of a semiconductor layer and the reflecting layer is used at the same time as a metal contact.

4. An optical cross-connect for switching a plurality of optical connections comprising an optical MEM switching array comprising a plurality of movable miniature mirrors respectively arranged in the light path of the individual optical connections, wherein at least some of the miniature mirrors respectively comprise a photosensitive layer which is arranged under a light-reflecting layer and which responds to the light components passing through the light-reflecting layer, in order to generate a monitoring signal.

5. A switching array based on MEM technology for an optical cross-connect, the switching array comprising plurality of movable mirrors, wherein at least some of the miniature mirrors respectively comprise a photosensitive layer which is arranged under a light-reflecting layer and which responds to the light components passing through the light-reflecting layer, in order to generate a monitoring signal.

6. A method for generating a monitoring signal during the all-optical switching of an optical connection in an optical cross-connect by means of a miniature mirror, the method comprising the step of detecting light components which pass through a reflecting layer of the miniature mirror in order to generate the monitoring signal.
